(19) United States
(12) Patent Application Publication
(10) Pub. No.: US 2026/0050557 A1
(43) Pub. Date: Feb. 19, 2026

(54) BUS CONTROL UNIT, PROCESSING APPARATUS, SYSTEM-ON-CHIP, BUS CONTROL METHOD, AND COMPUTER STORAGE MEDIUM

(71) Applicant: Alibaba Damo (Hangzhou) Technology Co., Ltd., Hangzhou (CN)

(72) Inventors: Linyong HUANG, Shanghai (CN); Zhe ZHANG, Beijing (CN); Shuangchen LI, Beijing (CN); Hongzhong ZHENG, Los Gatos, CA (US)

(21) Appl. No.: 19/274,226

(22) Filed: Jul. 18, 2025

(30) Foreign Application Priority Data
Aug. 14, 2024 (CN) 202411122735.1

(51) Int. Cl. G06F 13/12

(52) U.S. Cl. CPC G06F 13/122

(57) ABSTRACT

A bus control unit includes: a compression execution unit, configured to compress sparse data by using a compression algorithm, to obtain compression data and compression attribute information; and a compression control unit, configured to generate, according to an instruction format of a communication bus, a data signal carrying the compression attribute information and the compression data, and send the data signal through the communication bus, where the compression attribute information is used for decompressing the compression data to obtain the sparse data.

### BACKGROUND

### Technical Field

Embodiments of the present specification relate to the field of computer technologies, and in particular, to a bus control unit, a processing apparatus, a system-on-chip, a bus control method, and a computer storage medium.

### Description of the Related Art

Sparsity of parameter data of a neural network refers to the presence of a large number of values that are zero or close to zero in a weight matrix or an eigenvector. Sparsity of data widely exists in machine learning, for example, sparse feature data in a graph neural network or a pruning network. Using the sparsity may be combined with a model pruning and quantization technology, to further reduce a size of a model and accelerate an inference process.

For example, in a forward propagation process and a back propagation process, by calculating only an item corresponding to a non-zero weight, a large quantity of multiplication operations can be reduced, thereby accelerating a training process. Alternatively, algorithm implementation such as sparse matrix multiplication for sparse data can further improve calculation efficiency.

For another example, in a process of training or inferring a neural network, when sparse data is buffered, sparsity of the data can reduce memory occupied by the data of the neural network.

### BRIEF SUMMARY

The present specification provides a bus control solution, which improve parallel processing of the sparse data of the neural network between different processing apparatuses by efficiently transferring the sparse data between the different processing apparatuses through a communication bus.

Embodiments of the present specification provide a bus control unit, a processing apparatus, a system-on-chip, a bus control method, and a computer storage medium, to resolve the foregoing problem.

According to a first aspect of the embodiments of the present specification, a bus control unit is provided, including: a compression execution unit, configured to compress sparse data by using a compression algorithm, to obtain compression data and compression attribute information; and a compression control unit, configured to generate, according to an instruction format of a communication bus, a data signal indicating the compression attribute information and the compression data, and send the data signal through the communication bus, where the compression attribute information is used for decompressing the compression data to obtain the sparse data.

According to a second aspect of the embodiments of the present specification, a processing apparatus is provided, including: the bus control unit according to the first aspect.

According to a third aspect of the embodiments of the present specification, a system-on-chip is provided, including: the processing apparatus according to the second aspect; and a communication bus, where different processing apparatuses communicate with each other through the communication bus.

According to a fourth aspect of the embodiments of the present specification, a bus control method is provided, including: compressing sparse data by using a compression algorithm, to obtain compression data and compression attribute information; generating, according to an instruction format of a communication bus, a data signal indicating the compression attribute information and the compression data, where the compression attribute information is used for decompressing the compression data to obtain the sparse data; and sending the data signal through the communication bus.

According to a fifth aspect of the embodiments of the present specification, a bus control unit is provided, including: a processor, a memory, an internal bus interface, and an internal bus, where communication between the processor, the memory, and the internal bus interface is completed through the internal bus; and the memory is configured to store at least one executable instruction, and the executable instruction causes the processor to perform the method according to the fourth aspect.

According to a sixth aspect of the embodiments of the present specification, a computer storage medium, having a computer program stored therein, where the program, when executed by a processor, implements the method according to the fourth aspect.

In the solutions of the embodiments of the present specification, the compression execution unit compresses the sparse data to obtain the compression data and the compression attribute information, the compression control unit can encapsulate the compression data and the compression attribute information into the instruction format of the communication bus, and further can use the instruction format of the communication bus to transfer the compressed compression data and compression attribute information, so that the bus control unit on the receiving side can decompress the compression data according to the compression attribute information, thereby improving transfer efficiency of the communication bus, helping reduce or avoid buffering of the sparse data, and further improving calculation efficiency of the processing apparatus.

### BRIEF DESCRIPTION OF THE SEVERAL VIEWS OF THE DRAWINGS

To describe the technical solutions in the embodiments of the present specification or in the existing technology more clearly, the following briefly describes the accompanying drawings required for describing the embodiments or the existing technology. Apparently, the accompanying drawings described below are merely some embodiments recorded in the embodiments of the present specification, and those of ordinary skill in the art may further derive other accompanying drawings from these accompanying drawings.

FIG. 1 is a schematic structural block diagram of a system-on-chip according to some examples.

FIG. 2 is a schematic structural block diagram of a bus control unit according to some embodiments of the present specification.

FIG. 3 is a schematic diagram of some exemplary compression algorithms of the embodiments of FIG. 2.

FIG. 4 is a schematic block diagram of a bus control unit according to some examples of the embodiments of FIG. 2.

FIG. 5 is a schematic block diagram of a bus control unit according to some examples of the embodiments of FIG. 2.

FIG. 6 is a flowchart of steps of a bus control method according to some other embodiments of the present specification.

FIG. 7 is a schematic structural diagram of a bus control unit according to some other embodiments of the present specification.

### DETAILED DESCRIPTION

To make a person skilled in the art to better understand the technical solutions of the embodiments of the present specification, the technical solutions in the embodiments of the present specification are described clearly and completely below with reference to the accompanying drawings in the embodiments of the present specification. Apparently, the described embodiments are merely some rather than all of the embodiments of the present specification. All other embodiments obtained by a person of ordinary skill in the art based on the embodiments in the embodiments of the present specification shall fall within the protection scope of the embodiments of the present specification.

Example implementations of the embodiments of the present specification are further described herein with reference to the accompanying drawings of the embodiments of the present specification.

To improve parallel processing of the sparse data of the neural network between different processing apparatuses, a reliable bus control solution is provided, which efficiently transfer the sparse data between the different processing apparatuses through a communication bus such as an Advanced extensible Interface (AXI) bus.

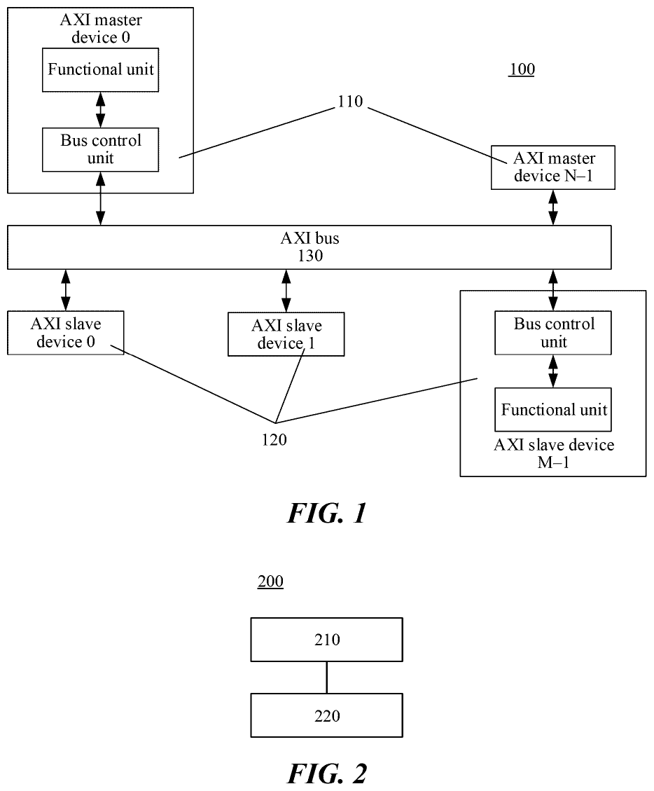

FIG. 1 is a schematic structural block diagram of a system 100, e.g., in a system-on-chip architecture, according to some examples. The system-on-chip 100 in FIG. 1 includes N processing apparatuses 110 (e.g., processing apparatuses 0 to N−1) configured as AXI master devices 0 to N−1 and M processing apparatuses 120 (e.g., processing apparatuses 0 to M−1) as AXI slave devices 0 to M−1. The processing apparatuses 110, 120 may be used for computation processing (for example, PE) and storage processing (for example, memory). Any processing apparatus 110 may perform bus communication with any processing apparatus 120 through an AXI bus 130.

In some examples, an AXI bus protocol is transfer based on a burst. For example, a read address channel, a read data channel, a write address channel, a write data channel, and the like are defined in some AXI bus protocols. An address channel carries a control message used to describe an attribute of transferred data. A write channel is used for data transfer to implement transfer from a “master device” to a “slave device”. The “slave device” uses a write response channel to complete a write transfer. A read channel is used to implement transfer of data from the “slave device” to the “master device”.

The AXI is a data transfer protocol based on a VALID/READY (e.g., enable/receive ready) handshake mechanism. A transfer source end uses VALID to indicate that an address/control signal and data are VALID, and a destination end uses READY to indicate that the destination can receive information.

For example, in the read/write address channel, read transfer and write transfer each have its own address channel, and a corresponding address channel carries address control information corresponding to transfer. In the read data channel, the read data channel carries read data and a read response signal, including a data bus (8/16/32/64/128/256/512/1024 bits) and a read response signal indicating completion of read transfer. In the write data channel, data information of the write data channel is considered to be buffered, and a “master” can initiate a new write transfer without waiting for a confirmation from a “slave” about a previous write transfer. The write channel includes a data bus (8, 16, . . . , or 1024 bits) and a byte line (used for indicating validity of an 8-bit data signal).

Signals of various channels are defined as follows:

### Global Signal

| Signal name | Signal source | Signal description |
|---|---|---|
| ACLK | Clock source | Global clock signal |
| ARESETn | Reset source | Global reset signal, active-low |

### Write Address Channel Signal

| Signal | Signal | |
|---|---|---|
| name | source | Description |
| awid | Master device | Write address identifier, to identify a group |
| | | of write signals |
| awaddr | Master device | Write address, to provide a write address |
| | | for write burst transfer |
| awlen | Master device | Burst length, to provide an actual number of |
| | | beats of burst transfer |
| awsize | Master device | Burst size, to provide a data volume of each |
| | | beat of burst transfer, that is, a bus width |
| awburst | Master device | Burst type |
| awuser | Master device | Extension signal |
| awvalid | Master device | Enable signal, to indicate validity of an |
| | | address control signal of a channel |
| awready | Slave device | Receive ready signal, to indicate that an |
| | | address and a corresponding control signal |
| | | can be received |

### Write Data Channel Signal

| Signal | Signal | |
|---|---|---|
| name | source | Signal description |
| wid | Master device | ID tag of one write transfer |
| wdata | Master device | Write data |
| wuser | Master device | Extension signal |
| wvalid | Master device | Enable signal, to indicate that this |
| | | write is valid |
| wready | Slave device | Receive ready signal, to indicate that write |
| | | data can be received |

### Read Address Channel Signal

| Signal | Signal | |
|---|---|---|
| name | source | Signal description |
| arid | Master device | Read address, to identify a group of write |
| | | signals |
| araddr | Master device | Read address, to provide a read address for one |
| | | write burst transfer |
| arlen | Master device | Burst length, to provide an actual number of |
| | | beats of burst transfer |
| arsize | Master device | Burst size, to provide a data volume of each |
| | | beat of burst transfer, that is, a bus width |
| arburst | Master device | Burst type |
| aruser | Master device | Extension signal |
| arvalid | Master device | Enable signal, to indicate that an address |
| | | control signal of this channel is valid |
| arready | Slave device | Receive ready signal, to indicate that the slave |
| | | device can receive an address and a |
| | | corresponding control signal |

### Read Data Channel Signal

| Signal | Signal | |
|---|---|---|
| name | source | Signal description |
| rid | Slave device | Read ID tag |
| rdata | Slave device | Read data |
| rpesp | Slave device | Read response, to indicate a state of read |
| | | transfer |
| ruser | Slave device | Extension signal |
| rvalid | Slave device | Enable signal, to indicate that this channel |
| | | signal is valid |
| rready | Master device | Receive ready signal, to indicate that the master |
| | | device can receive data and response |
| | | information |

FIG. 2 is a schematic structural block diagram of a bus control unit according to some embodiments of the present specification. The bus control unit 200 includes a compression execution unit 210 and a compression control unit 220.

For example, the compression execution unit 210 is configured to compress sparse data by using a compression algorithm, to obtain compression data and compression attribute information.

For example, the sparse data may be parameter data of a neural network such as a graph neural network or a sparse neural network, and the sparse data may be data in which there is a repeated zero character or another repeated character. The bus control unit may obtain the parameter data from a functional unit in a processing apparatus, and the functional unit is configured to perform an operation on the parameter data of the neural network such as the graph neural network or the sparse neural network.

For example, in some implementations, the compression algorithm is a run-length encoding (RLE) algorithm, the compression attribute information is a description character sequence, and a description character in the description character sequence is used for describing repeated characters in the sparse data.

In addition, the compression control unit 220 is configured to generate, according to an instruction format of a communication bus, a data signal indicating the compression attribute information and the compression data, where the compression attribute information is used for decompressing the compression data to obtain the sparse data.

For example, the encoded attribute information is transferred through a signal of a wuser/ruser port of an AXI bus. For example, the bus control unit may support at least a non-compression mode and a compression mode. The non-compression mode is used for transferring dense data (e.g., non-sparse data) between different processing apparatuses, and the compression mode is used for transferring sparse data between different processing apparatuses.

In the solutions of the embodiments of the present specification, the compression execution unit compresses the sparse data to obtain the compression data and the compression attribute information, the compression control unit can encapsulate the compression data and the compression attribute information into the instruction format of the communication bus, and further can use the instruction format of the communication bus to transfer the compressed compression data and compression attribute information, so that the bus control unit on the receiving side can decompress the compression data according to the compression attribute information, thereby improving transfer efficiency of the communication bus, helping reduce or avoid buffering of the sparse data, and further improving calculation efficiency of the processing apparatus.

In some examples, the compression control unit is configured to: generate, according to a write instruction format of the communication bus, a first data signal indicating write compression data and write compression attribute information, and send the first data signal to a downstream bus control unit through the communication bus. The first data signal may indicate write compression data and write compression attribute information in various ways and all are included in the scope of the disclosure. For example, the data signal may directly include the write compression data, the write compression attribute information, or both, or carry the write compression data and write compression attribute information in other manners; the write compression data, the write compression attribute information, or both may be multiplexed into in the data signal; the data signal may contain indexes, pointers or other values indicative of the write compression data, the write compression attribute information, or both; bits of one or more of the write compression data or write compression attribute information may be rearranged in the data signal. Further, the data signal may not contain but indicate storage locations of the compression data and write compression attribute information. For example, the sparse data is compressed, an instruction format is used to transfer the compression result of the sparse data to the downstream bus control unit, thereby improving transfer efficiency of the write data between the local processing apparatus and the downstream processing apparatus.

In some examples, the bus control unit includes a decompression control unit and a decompression execution unit. The decompression control unit is configured to obtain the compression data and the compression attribute information based on the instruction format of the communication bus. For example, the decompression control unit parses the data signal according to the instruction format of the communication bus, to obtain the compression data and the compression attribute information. The decompression execution unit is configured to decompress the compression data according to the compression attribute information, to obtain the sparse data. For example, the sparse data is compressed to obtain the compression data and the compression attribute information, and the decompression control unit can decompress the compression data according to the compression attribute information, thereby improving transfer efficiency of the communication bus, helping reduce or avoid buffering of the sparse data, and further improving calculation efficiency of the processing apparatus.

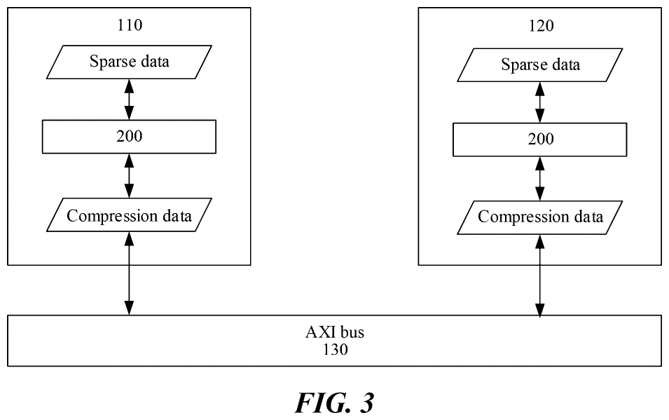

As shown in FIG. 3, in some implementations, sparse data is compressed by using a bus control unit 200 in a master device 110, to obtain compression data, and the compression data is transferred to a bus control unit 200 in a slave device 120 through an AXI bus 130. Alternatively, sparse data is compressed by using a bus control unit 200 in a slave device 120, to obtain compression data, and the compression data is transferred to a bus control unit 200 in a master device 110 through an AXI bus 130. In this embodiment of the present specification, compression processing independent of a processing architecture is implemented because compression in a bus control unit of an AXI bus does not affect logic of a functional unit.

As an illustrative example, the sparse data may be:

| | | | | | | | | | | | | | | | |
|---|---|---|---|---|---|---|---|---|---|---|---|---|---|---|---|
| 7 | 7 | 7 | 5 | 0 | 0 | 0 | 4 | 4 | 0 | 0 | 0 | 0 | 0 | 2 | 2 |
| 2 | 2 | 0 | 0 | 0 | 0 | 0 | 0 | 4 | 0 | 0 | 9 | 0 | 0 | 0 | 0 |

The sparse data is 32*4 bytes in the illustrative example, and after the sparse data is compressed by using a first compression algorithm, obtained compression data may be:

| | | | | | | | | | | |
|---|---|---|---|---|---|---|---|---|---|---|
| 7 | 5 | 0 | 4 | 0 | 2 | 0 | 4 | 0 | 9 | 0 |

Compression attribute information of the compression data may be:

| | | | | | | | | | | |
|---|---|---|---|---|---|---|---|---|---|---|
| 3 | 1 | 3 | 2 | 5 | 4 | 6 | 1 | 2 | 1 | 4 |

For example, a compression mode (for example, vanilla run-length encoding) of the first compression algorithm instructs each byte in the compression attribute information to indicate a quantity of repetitions of a byte corresponding to the byte in the compression data. Correspondingly, the compression ratio=[11*4 bytes (compression data)+11 bytes (wuser)]/32*4 bytes (original data)=44.1%.

Alternatively or additionally, the compression is performed by using a second compression algorithm, and obtained compression data is:

| | | | | | | | | | | | | | | | | |
|---|---|---|---|---|---|---|---|---|---|---|---|---|---|---|---|---|
| 7 | 7 | 7 | 5 | 3 | 4 | 4 | 5 | 2 | 2 | 2 | 2 | 6 | 4 | 2 | 9 | 4 |

Compression attribute information of the compression data is:

| | | | | | | | | | | | | | | | | |
|---|---|---|---|---|---|---|---|---|---|---|---|---|---|---|---|---|
| 0 | 0 | 0 | 0 | 1 | 0 | 0 | 1 | 0 | 0 | 0 | 0 | 1 | 0 | 1 | 0 | 1 |

A compression mode (zero encoding) of the second compression algorithm instructs each byte in the compression attribute information to indicate whether a byte corresponding to the byte in the compression data is zero. If the corresponding byte is non-zero, the byte is zero; or if the corresponding byte is zero, the byte indicates a quantity of repetitions of the zero byte. Correspondingly, the compression ratio=[17*4 bytes (compression data)+ (17 bits/8) (wuser)]/32*4 bytes (original data)=54.7% (zero encoding).

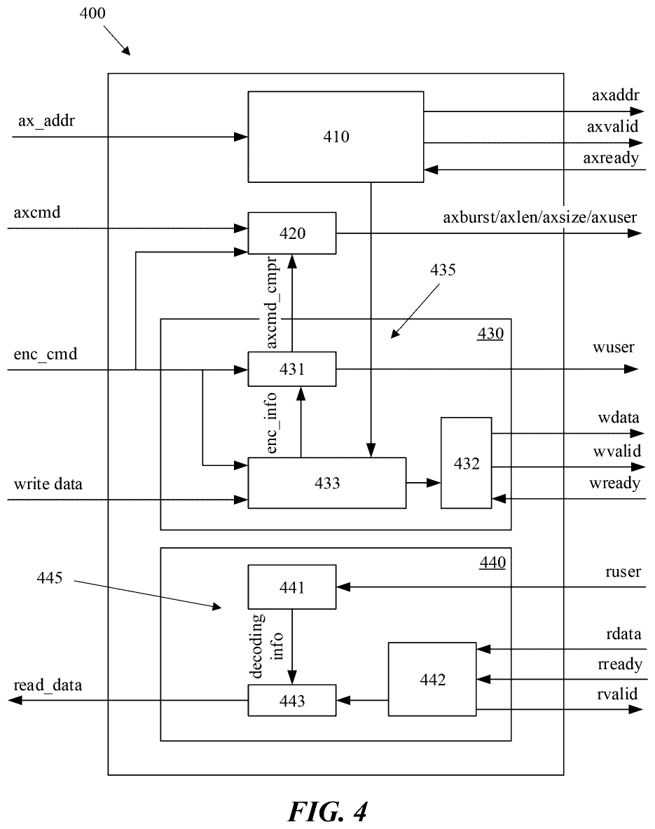

In some embodiments, a processing apparatus in which a bus control unit shown in FIG. 4 is located is used as a master device of a communication bus, and includes a write operation unit 430. The write operation unit 430 includes a compression execution unit 433 and a compression control unit 435, and the compression control unit 435 includes a compression instruction unit 431 and a write data unit 432.

Without loss of generality, the write instruction format includes a write extension signal and a write data signal. The compression control unit is, in some implementations, configured to: generate the write extension signal indicating, e.g., carrying, the write compression attribute information, generate the write data signal indicating, e.g., carrying, the write compression data, and send the write extension signal and the write data signal to the downstream bus control unit in parallel through the communication bus. In some examples, the write extension signal may be a signal wuser in a write compression data channel. It should be understood that, the write extension signal indicates, e.g., carries, the write compression attribute information of the write compression data, and the write data signal indicates, e.g., carries, the write compression data. In a bus protocol such as AXI, instruction formats of the write extension signal and the write data signal are fully used to transfer the compression data of the sparse data to the downstream bus control unit.

In some examples, the compression execution unit 433 receives a compression control instruction and a write data instruction including the sparse data, and compresses the sparse data (for example, write data) in the write data instruction according to the compression control instruction, to obtain the write compression data and the write compression attribute information. In some examples, the compression instruction unit 431 may receive a compression control instruction (enc_cmd), and transfer the compression control instruction to the compression execution unit 433 in the write operation unit 430.

Further, the compression execution unit 433 transfers the write compression data to the write data unit 432, and the write data unit 432 generates the write data signal (for example, wdata) indicating, e.g., carrying, the write compression data. The compression execution unit 433 transfers the write compression attribute information to the compression instruction unit 431, and the compression instruction unit 431 generates the write extension signal (for example, wuser) indicating, e.g., carrying, the write compression attribute information. For example, in response to the compression control instruction, the compression instruction unit 431 waits for the compression execution unit 433 to send the write compression attribute information, and generates the write extension signal after obtaining the write compression attribute information.

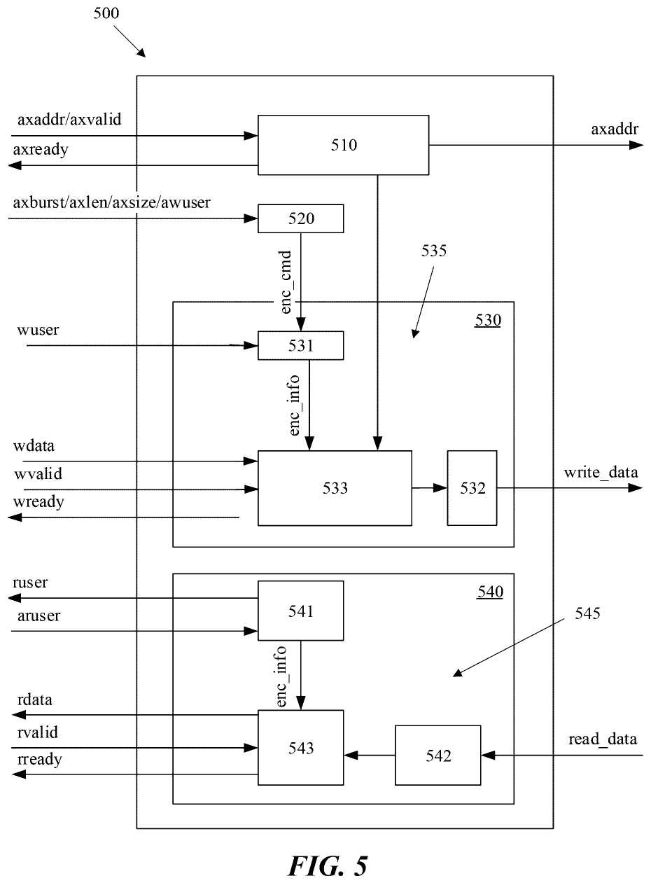

Further, a processing apparatus of a bus control unit shown in FIG. 5 may be used as a slave device of a communication bus, and includes a write operation unit 530. The write operation unit 530 includes a decompression execution unit 533 and a decompression control unit, and the decompression control unit 535 includes a decompression instruction unit 531 and a write data unit 532.

Without loss of generality, the decompression control unit is, in some implementations, configured to separately process, e.g., parse, a write data signal and a write extension signal according to a write instruction format of the communication bus, to obtain write compression data and write compression attribute information. The decompression execution unit is, in some implementations, configured to decompress the write compression data and the write compression attribute information, to obtain the sparse data. For example, the write data signal and the write extension signal received from the upstream bus control unit are processed, e.g., parsed, to obtain the write compression data and the write compression attribute information, and the write data signal and the write extension signal in the instruction format are used, thereby improving transfer efficiency of the write data between the local processing apparatus and the upstream processing apparatus.

In some examples, the decompression instruction unit 531 parses the write extension signal according to the instruction format, to obtain the write compression attribute information, and parses the write data signal according to the instruction format, to obtain the write compression data. For example, the decompression instruction unit 531 may obtain the write extension signal from the upstream bus control unit, and obtain the write data signal from the upstream bus control unit.

Further, the decompression execution unit 533 obtains the write compression attribute information and the write compression data from the decompression instruction unit 531. The decompression execution unit 533 decompresses the write compression data according to the write compression attribute information, to obtain the sparse data. The write data unit 532 writes the sparse data into a register of the local processing apparatus or a local memory in response to the write instruction signal.

It should be understood that, the write data unit 432 may send an enable signal (for example, wvalid) to the decompression execution unit 533, and the decompression execution unit 533 may send a receive ready signal (for example, wready) to the write data unit 432, so that when both the enable signal and the receive ready signal are valid, transfer of the write data signal (for example, wdata) indicating, e.g., carrying, the write compression data between the write data unit 432 and the decompression execution unit 533 is triggered.

Further, the bus control unit may further include an address instruction unit 410, 510. The address instruction unit 410 may receive a receive ready signal in an address channel from a downstream bus control unit 500, and send a ready signal to the compression execution unit 433, so that the compression execution unit 433 compresses the sparse data in the write data instruction according to the compression control instruction in response to the receive ready signal.

In addition, the address instruction unit 410 may receive an address instruction (for example, ax_addr), and send an address signal indicating, e.g., carrying, the write address to the downstream bus control unit. The address instruction unit 410 may further send an enable signal (for example, axvalid) to the address instruction unit 510, and the address instruction unit 510 sends a receive ready signal (for example, axready) to the address instruction unit 410, so that when both the enable signal and the receive ready signal are valid, transfer of the address signal (for example, axaddr) and the write instruction signal between the address instruction unit 510 and the address instruction unit 410 is triggered.

The bus control unit 400 in the processing apparatus used as a master device may further include a parameter instruction unit 420. The parameter instruction unit 420 receives a bus control instruction (for example, axcmd), processes, e.g., parses, the bus control instruction to obtain transfer transaction parameters, and generates a data parameter signal indicating, e.g., carrying, different transfer transaction parameters. For example, the transfer transaction parameters include a transfer transaction type (for example, a type of burst transfer in the AXI bus protocol, namely, burst type), an upper limit of a data length of transfer in a transfer transaction (for example, an upper limit of a quantity of bytes of burst transfer in the AXI bus protocol, namely, burst size), an actual data length of transfer in a transfer transaction (for example, an actual quantity of bytes of burst transfer in the AXI bus protocol, namely, burst length), and the like. Correspondingly, the parameter instruction unit 420 may further send data parameter signals to a downstream bus control unit. A read instruction signal and a write instruction signal may be further indicated in the bus control instruction.

Further, the compression instruction unit 431 generates a data length of the write compression data according to the compression attribute information (for example, enc_info), and sends the data length of the write compression data to the parameter instruction unit 420 (for example, through axcmd_cmpr). The parameter instruction unit 420 writes the data length of the write compression data into a data parameter signal corresponding to each data item. Without loss of generality, the bus control unit further includes a parameter instruction unit, configured to add a data length of the compression data to a data length field for describing the sparse data, generate a data parameter signal, and send the data parameter signal and the data signal to a downstream bus control unit in parallel. It should be understood that, the data length of the compression data is added to the data length field used for describing the sparse data, to replace the data length of the sparse data, thereby helping parse the data signal according to the data length of the compression data, and further improving the reliability of parsing the compression data while reusing the instruction format of the data parameter signal to transfer the compression data of the sparse data in a bus protocol such as AXI.

The bus control unit 500 in the processing apparatus used as a slave device may further include an address instruction unit 510. The address instruction unit 510 may receive an address signal in an address channel from an upstream bus control unit, and send a decompression request signal to the decompression execution unit 533 in response to the address signal, so that the decompression execution unit 533 decompresses the write compression data in the write data signal according to the write compression attribute information in response to the decompression request signal.

In addition, the address instruction unit 510 may further send a receive ready signal to the address instruction unit 410, and receive an enable signal sent by the address instruction unit 410, so that the address instruction unit 410 and the address instruction unit 510 trigger transfer of the address signal and the write instruction signal when both the enable signal and the receive ready signal are valid.

The bus control unit may further include a parameter instruction unit 520, and the parameter instruction unit 520 receives a data parameter signal that indicates, e.g., carries different transfer transaction parameters and that is sent by an upstream bus control unit 400. For example, the transfer transaction parameters include a transfer transaction type, an upper limit of a data length of transfer in a transfer transaction, an actual data length of transfer in a transfer transaction, and the like. In addition, the decompression instruction unit 531 may obtain the data length of the write compression data from the parameter instruction unit 520, and process, e.g., parse, the write data signal according to the data length to obtain the write compression data. Without loss of generality, the parameter instruction unit is further configured to: parse the data parameter signal, to obtain a data length of the compression data. The decompression control unit is further configured to: process, e.g., parse, the data signal according to the data length, to obtain the compression data, thereby improving reliability of parsing the compression data.

In some embodiments, the bus control unit 500 in the processing apparatus used as a slave device includes a compression unit 540. The compression unit 540 includes a compression execution unit 543 and a compression control unit 545, and the compression control unit 545 includes a compression instruction unit 541 and a read data unit 542. Without loss of generality, the compression control unit may obtain the sparse data from the upstream bus control unit, generate, according to a read instruction format of the communication bus, a second data signal indicating, e.g., carrying, read compression data and read compression attribute information, and send the second data signal to a downstream bus control unit through the communication bus. The second data signal may indicate read compression data and read compression attribute information in various ways and all are included in the scope of the disclosure. For example, the second data signal may directly include the read compression data, the read compression attribute information, or both, or carry the read compression data and read compression attribute information in other manners; the read compression data, the read compression attribute information, or both may be multiplexed into in the data signal; the data signal may contain indexes, pointers or other values indicative of the read compression data, the read compression attribute information, or both; bits of one or more of the read compression data or read compression attribute information may be rearranged in the data signal. Further, the second data signal may not contain but indicate storage locations of the compression data and read compression attribute information. For example, the sparse data is compressed, an instruction format is used to transfer the compression result of the sparse data to the downstream bus control unit 400, thereby improving transfer efficiency of the read data between the local processing apparatus and the downstream processing apparatus.

The bus control unit 400 in the processing apparatus used as a master device includes a read operation unit 440, the read operation unit 440 includes a decompression execution unit 443 and a decompression control unit 445, and the decompression control unit 445 includes a decompression instruction unit 441 and a read data unit 442. Without loss of generality, the decompression control unit is, in some implementations, configured to: separately process, e.g., parse, a read data signal and a read extension signal according to a read instruction format of the communication bus, to obtain read compression data and read compression attribute information (for example, decoding info). The decompression execution unit is, in some implementations, configured to decompress the read compression data and the read compression attribute information, to obtain the sparse data (for example, read data). For example, the read data signal (for example, rdata) and the read extension signal (for example, ruser) received from the downstream bus control unit are processed, e.g., parsed, to obtain the read compression data and the read compression attribute information, and the read data signal and the read extension signal in the instruction format are used, thereby improving transfer efficiency of the read data between the local processing apparatus and the downstream processing apparatus.

For example, the decompression instruction unit 441 generates, in response to the compression control instruction, the read extension signal indicating, e.g., carrying, the read compression attribute information, and then sends the read extension signal to the compression instruction unit 541. The read data unit 542 obtains a read instruction signal, processes, e.g., parses, the read instruction signal according to a read instruction format of the communication bus, and reads the sparse data from a register of the local processing apparatus or a local memory. The compression instruction unit 541 obtains the read extension signal from the upstream processing apparatus, and parses the read extension signal to obtain the read compression attribute information.

The compression execution unit 543 obtains the read compression attribute information from the compression instruction unit 541, obtains the sparse data from the read data unit 542, and compresses the sparse data according to the read compression attribute information, to obtain the read compression data.

The compression execution unit 543 generates a read data signal indicating, e.g., carrying, the read compression data, and sends the read data signal to the read data unit 442, so that the read data unit 442 processes, e.g., parses, the read data signal to obtain the read compression data.

The decompression execution unit 443 obtains the read compression attribute information from the decompression instruction unit 441, obtains the read compression data from the read data unit 442, and decompresses the read compression data according to the read compression attribute information, to obtain the sparse data.

It should be understood that the decompression instruction unit 441 may, process, e.g., parse, the read extension signal according to a read instruction format of the communication bus, to obtain the read compression attribute information. The read data unit 442 may process, e.g., parse, the read data signal according to a read instruction format of the communication bus, to obtain the read compression data.

The decompression execution unit 443 decompresses the read compression data and the read compression attribute information to obtain sparse data, then generates a read response signal that carries the sparse data and that is used for a read instruction signal, and feeds back the read response signal to a functional unit of the local processing apparatus.

It should be understood that, the read data unit 442 may send an enable signal (for example, rvalid) to the compression execution unit 543, and the compression execution unit 543 may send a receive ready signal (for example, rready) to the read data unit 442, so that the read data unit 442 and the compression execution unit 543 trigger transfer of the read data signal (for example, rdata) when the enable signal and the receive ready signal are both valid.

Without loss of generality, the parameter instruction unit in the bus control unit in the processing apparatus used as a master device is further configured to: parse the data parameter signal, to obtain a data length of the compression data. The decompression control unit is further configured to: parse the data signal according to the data length, to obtain the compression data, thereby improving reliability of parsing the compression data.

It should be appreciated that in the description herein, a “master device” or a “slave device” are referred to with respect to functions performed by a processing apparatus in the write transfer or the read transfer. A processing apparatus may function as a master device in a first data transfer scenario and may function as a slave device in a second data transfer scenario. A processing apparatus may include both the bus control unit 400 and the bus control unit 500, or a bus control unit may function either as a bus control nuit 400 or as a bus control nuit 500 in various data transfer scenarios.

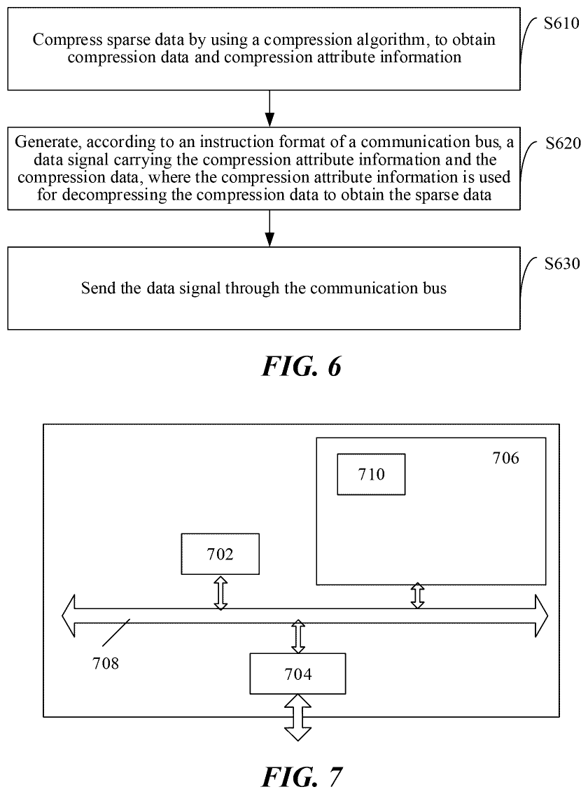

The following describes a bus control method according to some other embodiments of the present specification with reference to FIG. 6. The bus control method in FIG. 6 includes:
S610: Compress sparse data by using a compression algorithm, to obtain compression data and compression attribute information.
S620: Generate, according to an instruction format of a communication bus, a data signal indicating, e.g., carrying, the compression attribute information and the compression data, where the compression attribute information is used for decompressing the compression data to obtain the sparse data.
S630: Send the data signal through the communication bus.

In the solutions of the embodiments of the present specification, the compression execution unit compresses the sparse data to obtain the compression data and the compression attribute information, the compression control unit can encapsulate the compression data and the compression attribute information into the instruction format of the communication bus, and further can use the instruction format of the communication bus to transfer the compressed compression data and compression attribute information, so that the bus control unit on the receiving side can decompress the compression data according to the compression attribute information, thereby improving transfer efficiency of the communication bus, helping reduce or avoid buffering of the sparse data, and further improving calculation efficiency of the processing apparatus.

In some embodiments, the generating, according to an instruction format of a communication bus, a data signal indicating, e.g., carrying, the compression attribute information and the compression data includes: generate, according to a write instruction format of the communication bus, a first data signal indicating, e.g., carrying, write compression data and write compression attribute information, and send the first data signal to a downstream bus control unit through the communication bus.

In some embodiments, the write instruction format includes a write extension signal and a write data signal. The generating, according to a write instruction format of the communication bus, a first data signal indicating, e.g., carrying, write compression data and write compression attribute information includes: generating the write extension signal indicating, e.g., carrying, the write compression attribute information, generate the write data signal indicating, e.g., carrying, the write compression data. The sending the first data signal to a downstream bus control unit through the communication bus includes: sending the write extension signal and the write data signal to the downstream bus control unit in parallel through the communication bus.

In some embodiments, the bus control method further includes: adding a data length of the compression data to a data length field for describing the sparse data, generating a data parameter signal, and sending the data parameter signal and the data signal to a downstream bus control unit in parallel.

In some embodiments, the generating, according to an instruction format of a communication bus, a data signal indicating, e.g., carrying, the compression attribute information and the compression data includes: generate, according to a read instruction format of the communication bus, a second data signal indicating, e.g., carrying, read compression data and read compression attribute information, and send the second data signal to a downstream bus control unit through the communication bus.

In some embodiments, the bus control method further includes: processing, e.g., parsing, the data signal according to the instruction format of the communication bus, to obtain the compression data and the compression attribute information; and decompressing the compression data according to the compression attribute information, to obtain the sparse data.

In some embodiments, the processing, e.g., parsing, the data signal according to the instruction format of the communication bus, to obtain the compression data and the compression attribute information includes: separately processing a read data signal and a read extension signal according to a read instruction format of the communication bus, to obtain read compression data and read compression attribute information. The decompressing the compression data according to the compression attribute information, to obtain the sparse data includes: decompress the read compression data and the read compression attribute information, to obtain the sparse data.

In some embodiments, the processing the data signal according to the instruction format of the communication bus, to obtain the compression data and the compression attribute information includes: separately processing a write data signal and a write extension signal according to a write instruction format of the communication bus, to obtain write compression data and write compression attribute information. The decompressing the compression data according to the compression attribute information, to obtain the sparse data includes: decompress the write compression data and the write compression attribute information, to obtain the sparse data.

In some embodiments, the bus control method further includes: parse the data parameter signal, to obtain a data length of the compression data; and parse the data signal according to the data length, to obtain the compression data.

In some embodiments, the compression algorithm is a run-length encoding algorithm, the compression attribute information is a description character sequence, and a description character in the description character sequence is used for describing repeated characters in the sparse data.

For example implementation of steps in the bus control method, reference may be made to descriptions corresponding to corresponding units in the foregoing embodiments of the bus control unit, and corresponding beneficial effects may be achieved, which are not described herein again. It may be clearly understood by a person skilled in the art that, for the purpose of convenient and brief description, for a detailed working process of the foregoing bus control method, reference may be made to description of a corresponding unit in the foregoing embodiments of the bus control unit, and details are not described herein again.

FIG. 7 is a schematic structural diagram of a bus control unit according to another embodiment of the present specification. Specific implementation of the bus control unit is not limited in specific embodiments of the present specification.

As shown in FIG. 7, the bus control unit may include: a processor 702 configured to execute a program 710, an internal bus interface (Communications Interface) 704, a memory 706, and an internal bus 708.

The processor, the internal bus interface, and the memory communicate with each other by using an internal bus.

The internal bus interface is configured to communicate with another bus control unit or a server.

The processor is configured to execute the program, and may for example perform related steps in the foregoing method embodiments.

For example, the program may include program code, and the program code includes a computer operation instruction.

The processor may be a CPU, or an application specific integrated circuit (ASIC), or one or more integrated circuits configured to implement the embodiments of the present specification. The one or more processors included in the intelligent device may be processors of a same type, for example, one or more CPUs, or may be processors of different types, for example, one or more CPUs and one or more ASICs.

The memory is configured to store a program. The memory may include a high-speed RAM memory, and may further include a non-volatile memory, such as at least one disk memory.

The program may include computer instructions, and the program may for example cause, by using the computer instructions, the processor to perform the bus control method described in any one of the foregoing method embodiments.

For specific implementation of each step in the program, reference may be made to corresponding descriptions in corresponding steps, modules, or units in the foregoing method embodiments, and corresponding beneficial effects are achieved. Details are not described herein again. It may be clearly understood by a person skilled in the art that, for the purpose of convenient and brief description, for a detailed working process of the foregoing apparatus, device, or module, reference may be made to description of a corresponding process in the foregoing method embodiments, and details are not described herein again.

An embodiment of the present specification further provides a computer storage medium, having a computer program stored therein, where the program, when executed by a processor, implements the method provided in any one of the foregoing method embodiments. The computer storage medium includes but is not limited to a Compact Disc Read-Only Memory (CD-ROM), a Random Access Memory (RAM), a floppy disk, a hard disk, a magneto-optical disk, or the like.

An embodiment of the present specification further provides a computer program product, including a computer instruction. The computer instruction instructs a computing device to perform the bus control method in the foregoing method embodiments.

It should be noted that according to implementation needs, each part/step described in the embodiments of the present specification may be divided into more parts/steps, or two or more parts/steps or some operations of parts/steps may be combined into a new part/step, so as to achieve the objectives of the embodiments of the present specification.

The foregoing method according to the embodiments of the present specification may be implemented in hardware or firmware, or implemented as software or computer code that may be stored in a recording medium (such as a CD-ROM, a RAM, a floppy disk, a hard disk, or a magneto-optical disk), or implemented as computer code that is originally stored in a remote recording medium or a non-transitory machine readable medium and that is to be stored in a local recording medium and that is downloaded through a network, so that the method described herein may be processed by such software stored on a recording medium using a general-purpose computer, a dedicated processor, or programmable or dedicated hardware (such as an application-specific integrated circuit (ASIC) or a Field Programmable Gate Array (FPGA)). It may be understood that the computer, the processor, the microprocessor controller, or the programmable hardware includes a storage component (for example, a Random Access Memory (RAM), a Read-Only Memory (ROM), or a flash memory) that may store or receive software or computer code. When the software or the computer code is accessed and executed by the computer, the processor, or the hardware, the method described herein is implemented. In addition, when a general-purpose computer accesses code used for implementing the method shown herein, execution of the code converts the general-purpose computer into a special-purpose computer used for performing the method shown herein.

A person of ordinary skill in the art may realize that steps of units and methods of various examples described with reference to the embodiments disclosed in this specification can be implemented in electronic hardware, computer software, or a combination of the electronic hardware and the computer software. Whether the functions are executed in hardware or software depends on particular application and design constraint conditions of the technical solutions. Those skilled in the art may use different methods to implement the described functions for each particular application, but such implementations are not to be considered beyond the scope of the embodiments of the present specification.

The foregoing implementations are merely used for describing the embodiments of the present specification, but are not intended to limit the embodiments of the present specification. Persons of ordinary skill in the related art may make various changes and variations without departing from the spirit and scope of the embodiments of the present specification. Therefore, all equivalent technical solutions also fall within the scope of the embodiments of the present specification. The patent protection scope of the embodiments of the present specification should be limited by the claims.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computing system comprising a bus control unit, the bus control unit including:
a compression execution unit, configured to compress sparse data by using a compression algorithm, to obtain compression data and compression attribute information; and
a compression control unit, configured to generate, based on an instruction format of a communication bus, a data signal indicating the compression attribute information and the compression data, and send the data signal through the communication bus, wherein the compression attribute information is configured to be used for decompressing the compression data to obtain the sparse data.

2. The computing system according to claim 1, wherein the compression control unit is configured to:
generate, based on a write instruction format of the communication bus, a first data signal indicating write compression data and write compression attribute information, and send the first data signal to a downstream bus control unit through the communication bus.

3. The computing system according to claim 2, wherein the write instruction format comprises a write extension signal and a write data signal; and
the compression control unit is configured to: generate the write extension signal indicating the write compression attribute information, generate the write data signal indicating the write compression data, and send the write extension signal and the write data signal to the downstream bus control unit separately through the communication bus.

4. The computing system according to claim 1, wherein the bus control unit further comprises a parameter instruction unit, the parameter instruction unit configured to generate a data parameter signal indicating a data length of the compression data, and send the data parameter signal and the data signal to a downstream bus control unit separately.

5. The computing system according to claim 1, wherein the compression control unit is configured to: generate, based on a read instruction format of the communication bus, a second data signal indicating read compression data and read compression attribute information, and send the second data signal to a downstream bus control unit through the communication bus.

6. The computing system according to claim 1, wherein the bus control unit further comprises:
a decompression control unit, configured to parse the data signal based on the instruction format of the communication bus, to obtain the compression data and the compression attribute information; and
a decompression execution unit, configured to decompress the compression data based on the compression attribute information, to obtain the sparse data.

7. The computing system according to claim 6, wherein the decompression control unit is configured to: separately process a read data signal and a read extension signal based on a read instruction format of the communication bus, to obtain read compression data and read compression attribute information; and
the decompression execution unit is configured to: decompress the read compression data based on the read compression attribute information, to obtain the sparse data.

8. The computing system according to claim 6, wherein the decompression control unit is configured to: separately process a write data signal and a write extension signal based on a write instruction format of the communication bus, to obtain write compression data and write compression attribute information; and
the decompression execution unit is configured to: decompress the write compression data based on the write compression attribute information, to obtain the sparse data.

9. The computing system according to claim 4, wherein the parameter instruction unit is further configured to: process the data parameter signal, to obtain the data length of the compression data; and
the data length is configured to be used in processing the data signal to obtain the compression data.

10. The computing system according to claim 1, wherein the compression algorithm is a run-length encoding algorithm, the compression attribute information is a description character sequence, and a description character in the description character sequence indicates repeated characters in the sparse data.

11. A method, comprising:
by a first processing apparatus communicatively coupled to a communication bus,
compressing sparse data by using a compression algorithm, to obtain compression data and compression attribute information;
generating, based on an instruction format of the communication bus, a data signal indicating the compression attribute information and the compression data, wherein the compression attribute information is configured to be used for decompressing the compression data to obtain the sparse data; and
sending the data signal through the communication bus.

12. The method according to claim 11, further comprising:
by a second processing apparatus coupled to the communication bus,
processing the data signal based on the instruction format of the communication bus, to obtain the compression data and the compression attribute information; and
decompressing the compression data based on the compression attribute information, to obtain the sparse data.

13. The method according to claim 11, wherein the generating the data signal includes generating, based on a write instruction format of the communication bus, a first data signal indicating write compression data and write compression attribute information.

14. The method according to claim 13, wherein the write instruction format comprises a write extension signal and a write data signal;
the first data signal includes the write extension signal indicating the write compression attribute information and the write data signal indicating the write compression data; and
the sending the data signal through the communication bus includes sending the write extension signal and the write data signal separately through the communication bus.

15. The method according to claim 11, comprising:
by the first processing apparatus,
generating a data parameter signal indicating a data length of the compression data, and
sending the data parameter signal and the data signal through the communication bus separately.

16. The method according to claim 11, wherein the generating the data signal includes generating, based on a read instruction format of the communication bus, a second data signal indicating read compression data and read compression attribute information.

17. The method according to claim 16, wherein the read instruction format comprises a read extension signal and a read data signal;
the second data signal includes the read extension signal indicating the read compression attribute information and the read data signal indicating the read compression data; and
the sending the data signal through the communication bus includes sending the read extension signal and the read data signal separately through the communication bus.

18. The method according to claim 17, comprising:
by a second processing apparatus,
separately processing the read data signal and the read extension signal based on the read instruction format of the communication bus, to obtain the read compression data and the read compression attribute information; and
decompressing the read compression data based on the read compression attribute information to obtain the sparse data.

19. A computer storage medium, having a computer program stored therein, wherein the computer program, when executed by one or more processors, enables the one or more processors to, individually or collectively, implement acts comprising:
compressing sparse data by using a compression algorithm, to obtain compression data and compression attribute information;
generating, based on an instruction format of a communication bus, a data signal indicating the compression attribute information and the compression data, wherein the compression attribute information is configured to be used for decompressing the compression data to obtain the sparse data; and
sending the data signal through the communication bus.

20. The computer storage medium according to claim 19, wherein the acts further comprise:
receiving through the communication bus the data signal;
processing the data signal based on the instruction format of the communication bus, to obtain the compression data and the compression attribute information; and
decompressing the compression data based on the compression attribute information, to obtain the sparse data.
